(19) United States
(12) Patent Application Publication
(10) Pub. No.: US 2010/0125834 A1
(43) Pub. Date: May 20, 2010

(54) Dynamic Tracing on Java Exceptions

(75) Inventor: Dragan Matic, Oddenheim (DE)

Correspondence Address: BLAKELY SOKOLOFF TAYLOR & ZAFMAN LLP, 1279 OAKMEAD PARKWAY, SUNNYVALE, CA, 94085-4040, US

(73) Assignee: SAP AG, Walldorf (DE)

(21) Appl. No.: 12/274,280

(22) Filed: Nov. 19, 2008

(51) Int. Cl. G06F 11/36

(52) U.S. Cl. 717/125

(57) ABSTRACT

Embodiments of the invention provide a method and system for tracing Java bytecode. The system provides a user interface for selecting the methods, both primary and secondary, that the user desires to monitor. The user can record the execution of the program and playback the execution of the program while monitoring each of the designated methods and the variables and similar data related to those methods in order to identify a cause of an exception or error in the program.

### BACKGROUND

1. Field of the Invention

The invention relates to program debugging. Specifically, the embodiments of the invention relate to a method and system for dynamically tracing JAVA exceptions.

2. Background

Debugging tools for JAVA programs rely on the execution of the program in a development environment and the insertion of debugging specific instructions within the source code of the JAVA application. Inserting these instructions into the source code requires significant programmer effort. Executing these debugging specific instructions is computationally intensive and requires the use of extra computational resources. The speed of execution of the program is diminished. The JAVA virtual machine must also be run in a debug mode and the source code must be compiled with a debugging setting. Making these changes or having this control is not always possible or efficient.

Further, when an error occurs and the debugging instructions are utilized to generate a trace or print a stack related to the program, a large amount of trace data is generated that is difficult for a human being to review and utilize. A large amount of data is presented in a log or text file where it is difficult to see the inter-relationship between the different aspects of a program when viewing this trace file. This obscures the underlying errors that cause any exception that is being debugged.

Generally, debugging tools do not provide a continuous, real time update of the values of variables within each method of the program. Rather, the only variable value data that is available are the values of the variables at the time that the error or exception occurred. Recreating the conditions that lead to the exception in a real time scenario is a painstaking process. This type of track can be provided in some development environments, but this does not assist in debugging in the actual runtime environment of the program.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a diagram of one embodiment of a system for dynamic JAVA bytecode tracing.

FIG. 2 is a flowchart of one embodiment of a process for tracing JAVA bytecode.

FIG. 3 is a diagram of one embodiment of a user interface for JAVA bytecode tracing.

### DETAILED DESCRIPTION

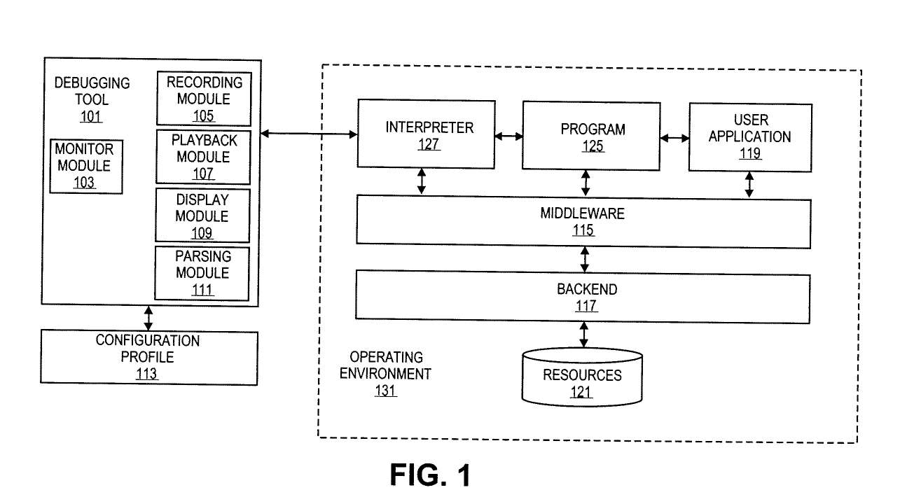

FIG. 1 is a diagram of one embodiment of a system for dynamically tracing JAVA bytecode. JAVA bytecode is a compiled form of the JAVA programming language developed by SUN Microsystems, Inc. of Santa Clara, Calif. The system includes a debugging tool 101 and a program 125 running in program operating environment 131. The debugging tool 101 interacts with the program operating environment 131 to monitor the execution of a program 125 in the program operating environment 131. The program 125 being monitored is a JAVA program that is being executed and is in the form of JAVA bytecode. The original JAVA source code is not required for purposes of tracing the JAVA bytecode. The program 125 can run in its real world environment, as represented by the program operating environment 131. This allows debugging outside of a development environment without having to run a JAVA virtual machine (JVM) in a debugging mode or compiling the program 125 specifically for debugging. The program 125 can be any type of program including a user application, middleware 115, backend software 117 or similar software modules. The program 125 can also be a client application, a server application or a component of a distributed application. The program 125 can interact with user applications 119, middleware 115 or backend software 117 to access resources 121.

The program operating environment 131 is executed on a server platform, on a workstation, in a distributed environment or in a similar computing environment. Computers in a distributed environment can communicate over a local area network (LAN), a wide area network (WAN) or similar network. The same program operating environment 131 can execute the debugging tool 101. In another embodiment, the debugging tool 101 executes in a separate program operating environment networked to the program operating environment 131.

In one embodiment, the debugging tool 101 is assisted in the monitoring of the program 125 through a set of interpreters 117 in the program operating environment 131. A ‘set,’ as used herein, refers to any positive whole number of items including one item. In one embodiment, the interpreter is in a second language that is used by the debugging tool 101 to interact with the executing JAVA program. For example in one embodiment the interpreter 117 is a CLApp interpreter by SAP Aktiengesellschaft of Waldorf, Germany. In another embodiment, the interpreter 117 can be a specialized JAVA program or modification to a JAVA virtual machine.

The debugging tool 101 can include a monitor module 103, recording module 105, playback module 107, display module 109, and parsing module 111. Each of these modules may be separate program or may be components of a larger program. Any combination of these modules may interact with a configuration profile 113. The configuration profile 113 can include settings for each of the respective modules. In one embodiment, the configuration profile 113 also includes a set of instructions or batch information to automate or drive the monitoring of a program 125.

A monitor module 103 manages the communication between the debugging tool 101 and the interpreter 117 that interact and monitor the status of the program 125 and related environmental variables in the program operating environment 131 during the execution of the program 125. The module 103 can also drive and control the interaction between the other modules in the debugging tool 101 such as the recording module 105, playback module 107, display module 109 and parsing module 111. The monitor module 103 can be instanced such that each program 125 that is monitored or each monitored sub-component of the program 125 is tied to or managed by a separate monitor module 103 instance. The monitor module 103 can also interact with the display module 109 to provide the user interface for the debugging tool 103 through which the user can view variable information, stack information and similar information regarding the program 125. Also, the user can manage the recording and playback of the execution of the program 125 through display module 109 and monitor module 103.

A recording module 105 interacts with the executing program 125 to record each of the steps in the execution of the program. As the program executes, the recording module 105 logs each of the steps of the program 125. The recording module 105 can receive an update on the progress of the program 125 through the interpreter 117, as well as, the monitor module 103. The recorded steps of the execution of the program 125 can then be re-executed by the playback module 107 to allow the user to move to any point in the execution of the program 125 for purposes of viewing the variable values and similar state information for debugging errors that occur during the execution of the program 125.

The playback module 107 can move the progress of the recorded execution of the program 125 forward by any number of steps. This can be done by the user of the debugging tool 101, who can set the automated pace for progressing through the program 125 or can set a particular spot or range in the program 125 over which the playback is to occur by setting a program counter or similar indicator of a location in the program 125 being monitored. The user can interact with the playback module 107 through a graphical user interface provided by the display module 109 and monitor module 103 or similar component of the debugging tool 101.

The parsing module 111 takes the bytecode of the program 125 being monitored to identify the function of each bytecode within that program 125. The parsing module 111 maintains a data structure that tracks the variable state of each variable and method of the program 125 and similar information related to the program 125 as it is received from the interpreter 117. The parsing of the bytecode allows the monitor module 103 to display the instructions to the user through the display module 109 and to allow the user to designate locations in the bytecode to stop or monitor the execution. In addition, the parsing module 111 can assist in directing the interpreter 127 to insert trace instructions into the bytecode to enable the playback, recording and monitoring directed by the user.

The display module 109 generates the graphical user interface for viewing the JAVA bytecode by relying on the data collected and provided by the parsing module 111 and the interpreter 117. The display module 109 can also generate a user interface for interacting with the other modules including the recording module 105, playback module 107 and monitor module 103. The display module 109 could also display other environmental variable information related to the debugging of the program 125 including stack trace information, method information, progress information, exception information and similar information relevant to debugging the program.

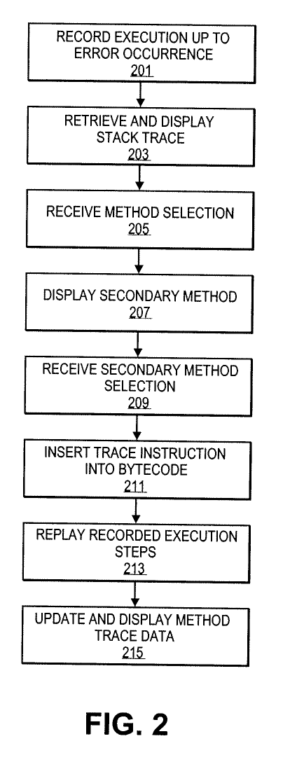

FIG. 2 is a flowchart of one embodiment of a process for JAVA bytecode tracing. In one embodiment, the process for JAVA bytecode tracing is initiated by selecting a program to trace and initiating the recording of the execution of that program up to the occurrence of the error (block 201). At the point of the error occurrence, the stack trace is retrieved and displayed for the user (block 203). Displaying the stack trace shows to the user the set of methods and calls that have been executed during the running of the program. This gives the user an indication of the location of the program and the conditions in the program at the time that the exception occurred. The recording is initiated by the recording module and works in conjunction with the interpreter and parsing module that provide the program bytecode and log its progress.

The display of the stack trace is connected with the display of a user interface mechanism that allows the user to select any of the methods in the stack trace or otherwise involved in the execution of the program. The user can select a specific method or a specific iteration within the method, subsection of the method or similar point of execution (block 205). In one embodiment, a number of methods or similar subcomponents of the program can be selected for tracing. Upon receiving a selection of a method or subsection of a method, a secondary display of methods can be generated and offered to the user to allow the user to select any of these additional secondary methods or sub-components of methods for tracing. A secondary method is a method or aspect of the program that reads or similarly relies on the fields in a primary method or section of a program. Secondary methods and similar aspects of the program can be determined by searching through the JAVA bytecode for operators that read a field variable or similar aspect of a primary method or portion of the bytecode. A user can interact with the user interface to select any number of secondary or primary methods for tracing (block 209).

In response to the selection and confirmation of the secondary and primary methods of the program by the user, trace instructions are inserted into the bytecode by the interpreter at the direction of the debugging tool (block 211). The insertion of trace instructions can be accomplished by bytecode weaving or by the defining of an agent that implements the JAVA virtual machine tool interface, which is part of all JAVA runtime environments since version 1.5. The trace instructions can be utilized to gather static or dynamic information, although typically static information can be tracked and obtained without the use of trace instructions. The trace instructions can be utilized to get the value of each variable at each call of a method or at each loop step in a method and to track the path of execution through a method. Once the appropriate trace instructions have been inserted into the bytecode or the appropriate agents have been generated, the user can begin the replay of the recorded execution steps (block 213).

The playback of the recorded execution steps can be done at any speed or at any increment. A user can progress through the execution of the program instruction by instruction, by blocks of instructions or by designating specific ranges of the instructions to be monitored or by similarly traversing the JAVA bytecode. As the recorded execution is played back, the variables from the traced methods and portions of the bytecode are continuously updated to reflect the changes caused by the execution of the bytecode at the current increment setting (block 215). In this way, the user can more easily identify the cause of an exception or similar error in the JAVA bytecode.

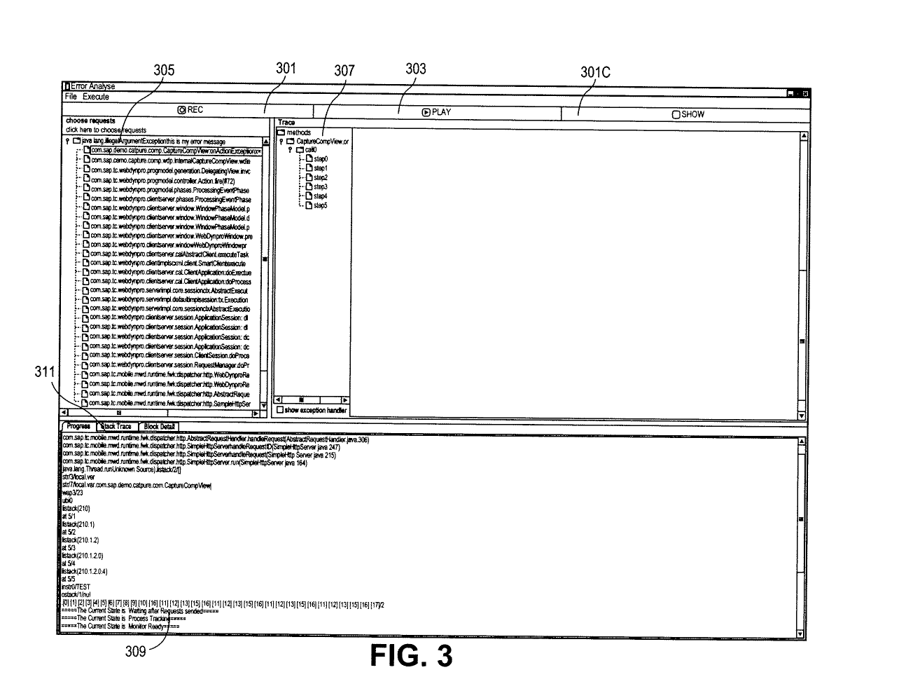

FIG. 3 is a diagram of one embodiment of the user interface for the bytecode tracing program. In one embodiment, the bytecode tracing program is generated by the display module. The user interface may include a record button 301, a play button 303, an exception display window 305, a trace window 307, a progress window 309 and a stack trace window 311. These windows and user interface options are presented here as a unitary user interface that is generated by the display module or similar component of the debugging tool. However, one of ordinary skill in the art will understand that any of these user interface elements can be substituted with other equivalent user interface elements. Also, these user interface elements can be organized differently with different hierarchies, layering or ordering of windows or similar reorganization of the user interface elements.

A record button 301 or similar user interface option can be selected by the user to indicate that a currently selected program or segment of a program is to be executed and have that execution recorded. The recorded execution is a log of the execution of each instruction in the program until an exception or similar error is encountered in the execution of the program. The specific bytecode sequence that is executed can be recorded or similar information about the path of execution for the program can be recorded.

Each of the exceptions or errors in the program can be displayed in the exception window 305. The exception window 305 can display any amount of information about the execution of the program that is available and generated by the exception. The exceptions may be organized into a hierarchy where each of the exceptions is related to a specific program or segment of a program.

The play button 303 can be utilized by the user to initiate playback of a recorded program execution. The playback can be done at any playback speed or increment. A user can set preferences or utilize a configuration profile to manage the playback of the recorded program. During the playback of the program the current status of traced or monitored variables can be displayed through the user interface. In one embodiment, these updates can be displayed in a specific window such as the progress window or similar window.

The record and play buttons are presented as simple toggle user interface options. However, one of ordinary skill in the art would understand that any equivalent or similar user interface mechanism such as a slider, range indicator or a similar user interface mechanism can be utilized to designate the portion of the program to be recorded or played back.

A progress window 309 shows the changes in the output of the program in each increment as it is played back by the play option or during the initial regular execution which is being recorded by the record option. Any amount or level of detail can be displayed in the progress window. A program that has inserted trace instructions or agents that are monitoring the specific variables or similar data related to the program can be continuously updated in the progress window 309 or similar window.

In one embodiment, the user interface may also include a stack trace window. A stack trace window provides a listing of all of the calls and iterations of loops that are present in the stack at the time that the error or exception occurs. Similarly, trace window 307 shows the path or progress of the playback of the recorded program based on the trace instructions that were inserted in that program based on user designation of the methods and bytecode sections to be monitored. A user can navigate to a particular level or layer of the program that is being traced by selecting any of the calls, methods or stacks provided in the trace window. This allows the user to easily navigate through and identify sections of a program that are responsible for causing the exception.

In one embodiment, the dynamic JAVA bytecode tracing system may be implemented as hardware devices. In another embodiment, these components may be implemented in software (e.g., microcode, assembly language or higher level languages). These software implementations may be stored on a computer-readable medium. A “computer-readable” medium may include any medium that can store or transfer information. Examples of a computer-readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. For example, the embodiments describe the tracking of JAVA bytecode, however, one skilled in the art would understand that the principles and components described herein could be applied to tracing errors in similar languages and operating environments. The specification and drawings are, accordingly, to be regarded in an illustrative rather than a restrictive sense.

What is claimed is:

1. A method for data access comprising:
receiving an indicator of a method to trace;
inserting a trace instruction into bytecode of the method; and
displaying trace data of the method.

2. The method for data access of claim 1, further comprising:
recording execution of a program including the method.

3. The method for data access of claim 1, further comprising:
retrieving an execution stack to generate a list of methods; and
displaying the list of methods.

4. The method for data access of claim 1, further comprising:
retrieving static information about each method of a stack trace.

5. The method for data access of claim 4, further comprising:
collecting dynamic trace information for the method.

6. The method for data access of claim 1, further comprising:
playing back a recorded execution of a program including the method.

7. The method of claim 1, further comprising:
generate a list of methods that read fields of the method.

8. The method of claim 6, further comprising:
displaying a change in variable value in a program with each step through playback.

9. The method of claim 1, wherein the trace instruction provides a variable value or path location with the method.

10. A system for debugging a program in bytecode format comprising:
a user interface module to display a list of methods of the program and receive a selection of a method; and
a program modification module to insert a trace instruction into the program to generate trace data for the method.

11. The system for debugging a program of claim 10, further comprising:
a monitor program to control execution of the program and detect an error.

12. The system for debugging a program of claim 10, further comprising:
a recording module to track execution of the program.

13. The system for debugging a program of claim 10, further comprising:
a playback module to manage execution of the program.

14. A computer readable medium having stored therein a set of instructions, which when executed, cause the computer to perform a set of operations comprising:
inserting a trace instruction into bytecode of a program; and
monitoring trace data from the trace instruction during execution of the program.

15. The computer readable medium of claim 14, having stored therein a further set of instructions, which when executed cause the computer to perform a further set of operations comprising:
displaying a set of methods from a stack trace; and
receiving a selection of a method from the set of methods.

16. The computer readable medium of claim 14, having stored therein a further set of instructions, which when executed cause the computer to perform a further set of operations comprising:
recording execution of the program.

17. The computer readable medium of claim 14, having stored therein a further set of instructions, which when executed cause the computer to perform a further set of operations comprising:
generating a list of methods that read fields of a method identified in a stack trace.

18. The computer readable medium of claim 14, having stored therein a further set of instructions, which when executed cause the computer to perform a further set of operations comprising:
collecting trace data including static and dynamic data for a method.

19. The computer readable medium of claim 14, having stored therein a further set of instructions, which when executed cause the computer to perform a further set of operations comprising:
displaying updated trace data for each execution step of the program.

20. The computer readable medium of claim 14, having stored therein a further set of instructions, which when executed cause the computer to perform a further set of operations comprising:
identifying an error in program execution.
